(19) United States
(12) Patent Application Publication
(10) Pub. No.: US 2012/0011354 A1
(43) Pub. Date: Jan. 12, 2012

(54) BOOT LOADING OF SECURE OPERATING SYSTEM FROM EXTERNAL DEVICE

(75) Inventor: Kelly Owen, Los Alamitos, CA (US)

(73) Assignee: EncryptaKey, Inc., Cypress, CA (US)

(21) Appl. No.: 13/176,605

(22) Filed: Jul. 5, 2011

Related U.S. Application Data
(60) Provisional application No. 61/361,326, filed on Jul. 2, 2010.

(51) Int. Cl. G06F 9/00

(52) U.S. Cl. 713/2

(57) ABSTRACT

A device for establishing a secure computing environment on a host computer. The device can include an interface configured to couple to the host computer. The device can also include a configuration module configured to identify a file that comprises configuration settings of the host computer's native boot loader that is used to load the host computer's native operating system. The configuration module can create a backup copy of the configuration settings of the native boot loader. The device includes a memory that holds a secure operating system. The device can also include a modification module configured to modify the configuration settings of the host computer's native boot loader to cause the secure operating system to be loaded from the device in place of the native operating system.

### CROSS-REFERENCE TO RELATED APPLICATIONS

This application claims priority to U.S. Provisional Patent Application No. 61/361,326, filed Jul. 2, 2010, and entitled “BOOT LOADER PROCESS,” which is hereby incorporated herein by reference in its entirety to be considered part of the specification.

### BACKGROUND OF THE INVENTION

1. Field of the Invention

Embodiments of the invention generally relate to boot loading of operating systems. More particularly, embodiments of the invention generally relate to methods for booting an operating system that is stored on an external device.

2. Description of the Related Art

Typical computers use an operating system to manage and control the available computing resources. An operating system generally includes computer-readable instructions that are read and executed by a processor from random access memory (RAM). When a computer is started, the operating system can be loaded into the RAM using one or more boot loaders. In some computers, BIOS firmware is stored in a non-volatile read only memory (ROM). The BIOS firmware can be used to identify a bootable device, such as a hard disk drive (HDD), that is communicatively coupled to the computer and to load a boot sector (e.g. the master boot record) from the bootable device. The boot sector can include a boot loader that then loads the operating system from the bootable device into RAM so that it can be executed by the processor.

### SUMMARY OF THE INVENTION

In some embodiments, a device for establishing a secure computing environment on a host computer comprises: an interface configured to couple to the host computer; a configuration module configured to identify a file that comprises configuration settings of the host computer's native first boot loader that is used to load a native first operating system that is installed on the host computer, and to create a backup copy of the configuration settings on the host computer; a memory comprising a second operating system; a modification module configured to modify the configuration settings of the host computer's native first boot loader to cause the second operating system to be loaded from the device in place of the native first operating system; and a restart module configured to cause the host computer to restart.

In some embodiments, a method for establishing a secure computing environment on a host computer comprises: identifying a file that comprises configuration settings of the host computer's native first boot loader that is used to load a native first operating system that is installed on the host computer; creating a backup copy of the configuration settings on the host computer; modifying the configuration settings of the host computer's native first boot loader to cause a second operating system to be loaded from an external device that is communicatively coupled to the host computer in place of the native first operating system; and causing the host computer to restart, wherein the method is at least partially performed by computer hardware.

In some embodiments, a non-transitory computer-readable storage comprises instructions that, when executed, establish a secure computing environment on a host computer according to a method that comprises: identifying a file that comprises configuration settings of the host computer's native first boot loader that is used to load a native first operating system that is installed on the host computer; creating a backup copy of the configuration settings on the host computer; modifying the configuration settings of the host computer's native first boot loader to cause a second operating system to be loaded from an external device that is communicatively coupled to the host computer in place of the native first operating system; and causing the host computer to restart.

### BRIEF DESCRIPTION OF THE DRAWINGS

Various embodiments and features of devices, systems, and methods will be described with reference to the following drawings. The drawings, associated descriptions, and specific implementation are provided to illustrate embodiments of the invention and not to limit the scope of the disclosure.

FIG. 1 is a block diagram of a portable device for establishing a secure computing environment in a host computer;

FIG. 2 is a top perspective view of one embodiment of the portable device of FIG. 1; and

FIG. 3 is a flow chart of an embodiment of a method for loading a secure operating system from a portable device (e.g., the portable device of FIG. 1) onto a host computer.

### DETAILED DESCRIPTION OF THE PREFERRED EMBODIMENT

Devices, systems, and methods for establishing a secure computing environment in a host computer are disclosed. In some embodiments, this is done using an external, portable device that interfaces with the host computer (e.g., via a USB port) to create a secure computing platform from which to perform a variety of computing tasks. For example, the device can be used to boot a host computer with a secure operating system stored on the device that helps to diminish the probability that the user's private information will be compromised while using the host computer. The secure operating system enhances the security of, for example, online transactions performed using the host computer by helping to protect a user's private information against malware or other security threats that may exist on the host computer and that would otherwise endanger the security of transactions performed using the host computer. Operating the host computer under the control of the secure operating system can also help protect a user's private files that may be stored on the portable device.

In some embodiments, the secure operating system helps protect a user's private information against malware by not accessing the host computer's hard disk drive (HDD), which is typically the source of such malware. For example, the secure operating system can be loaded to the host computer's volatile, or temporary, memory (e.g., RAM) from the portable device. Once loaded, the secure operating system can operate within the host computer's volatile memory, substantially without accessing data from, or storing data to, the computer's non-volatile memory, such as the HDD. Since the secure operating system does not substantially access the HDD, many, if not all, of the security threats from malware stored on the HDD are foregone. For example, if a key-logger program capable of monitoring a user's keystrokes and transmitting them to an unauthorized party were to be installed on the host computer, the secure operating can substantially disable the key-logger program by not accessing the HDD where it resides, thus not allowing it the opportunity to execute.

The user's private data can be manipulated by the host computer in its attached volatile memory. After each usage, the computer's volatile memory can be erased without leaving the types of trace information that may still remain in non-volatile memory even after the information is believed to have been deleted or otherwise “erased.” This process has the benefit of allowing for the completion of computing tasks such as online transactions without leaving information associated with the transactions that have been performed under the operation of the secure operating system on the host computer.

The devices, systems, and methods described herein can be used in conjunction with any of the devices, systems, and methods described in the following U.S. patent and U.S. patent publications, which are hereby incorporated herein by reference in their entirety to be considered part of the specification: U.S. Pat. No. 7,780,080 and U.S. Patent Publications 2008/0016005, 2007/0282754, 2007/0280510, 2007/0257105, and 2007/0280509.

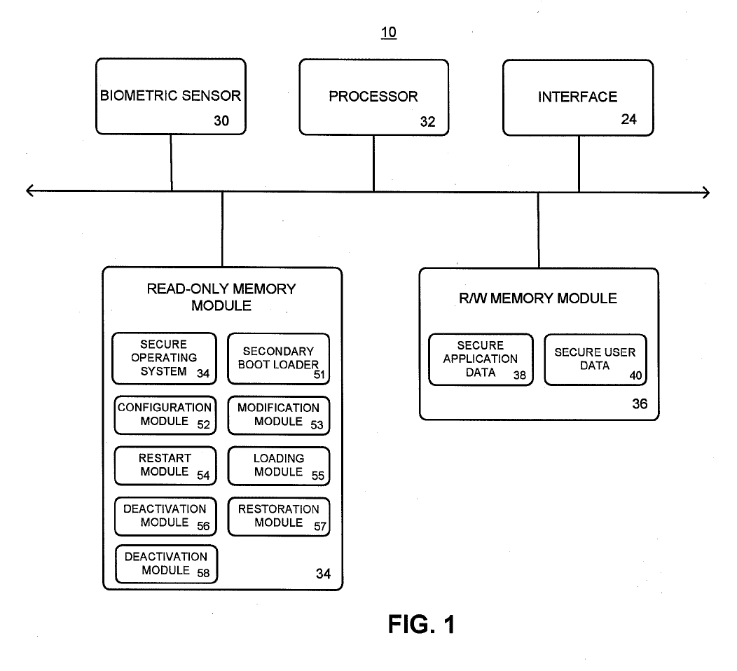

FIG. 1 is a block diagram of a portable device 10 for establishing a secure computing environment in a host computer. Certain embodiments of the device 10 are similar in appearance to flash drives of the sort that provide portable electronic data storage. As illustrated, the device 10 includes an interface 24 for communicatively coupling the device 10 to a host computer (not shown). In certain embodiments, the interface 24 comprises a USB interface, though other types of interfaces are also suitable, whether wired or wireless. For example, FIREWIRE, BLUETOOTH, Wi-Fi, and Wireless USB interfaces, combinations of the same, or the like are also suitable.

The portable device 10 can include a processor 32. In certain embodiments, the processor 32 has a 32-bit word size, though other word sizes are also acceptable. The processor 32 can be configured to control certain operations of the device 10. For example, the processor 32 can control the interface (e.g., USB interface) 24 with a host computer (not shown). The processor 32 can control access to memory modules 34 and 36. The processor 32 can also perform other functions as desired, including encryption of information transferred between the device 10 and other external devices, or between the various components of the device 10.

The device 10 can include one or more memory modules. In certain embodiments, the device 10 includes at least two physically separate memory modules 34, 36 that are secured (e.g., biometrically) so that access to the memory modules 34, 36 is at least partially restricted based on whether a user has authenticated his identity. As illustrated in FIG. 1, the memory module 34 comprises a read-only memory module 34. Many different types of read-only memory can be used, including an electrically erasable programmable read-only memory (EEPROM) module. In some embodiments, the memory module 34 is not a read-only memory module but is nonetheless write-protected. For example, the memory module 34 may be write-protected by configuring it so that it cannot be written to without a user first having authenticated his identity.

In some embodiments, the read-only memory module 34 stores the computer code for a secure operating system 35. The secure operating system 35 comprises computer-readable instructions for controlling a host computer. In certain embodiments, the secure operating system 35 can be advantageously loaded from the device 10 into the volatile memory (e.g., RAM memory) of a host computer communicatively coupled to the device 10 through the interface 24. The secure operating system 35 generally includes enough basic functionality to operate the host computer, communicate with I/O devices attached to the host computer, and to initiate network connections. For example, the secure operating system 35 can include a filing system, a graphical user interface, a process management module, a memory management module, a networking management module, I/O controllers, peripheral device drivers, etc. The secure operating system 35 can also be packaged with, for example, a VPN connection utility, a firewall module, a virus scanner module, security probes, a web browser module, various types of file editing software (e.g., word processing software, spreadsheet software, multimedia playback/editing software), combinations of the same or the like.

In some embodiments, the secure operating system 35 operates solely from the host computer's RAM memory and the one or more memory modules 34 and 36 of the device 10, thus circumventing the host computer's non-volatile storage memory (e.g., the host computer's HDD). For example, once the secure operating system 35 is loaded, the host computer's HDD can be partially disabled or, in some cases, completely disabled. In some embodiments, the host computer's HDD is powered down while the host computer is under the control of the secure operating system 35 or otherwise placed in a state where the internal disks of the HDD do not rotate such that no information can be read from or written to the HDD while the host computer is under the control of the secure operating system 35.

The secure operating system 35 is configured to control operation of the host computer independently from the host computer's native operating system. For instance, the operating system 35 can advantageously include a limited number of basic device drivers usable for certain peripherals of the host computer (e.g., display, keyboard, mouse) and/or cause the host computer to operate in a type of “safe mode.” In other embodiments, the operating system 35 functions in combination with the host computer's native operating system and/or a limited number of device drivers stored on non-volatile memory of the host computer.

In certain embodiments, any malware, such as spyware, viruses, key-logger programs, or other malicious software that may exist in the host computer's non-volatile storage memory is, thus, rendered non-functional while the host computer is under the control of the secure operating system 35. Furthermore, the fact that the memory module 34, which stores the secure operating system 35, is read-only or otherwise write-protected makes the secure operating system 35 resistant to malware threats, since malicious software cannot be saved to the read-only memory module, or otherwise incorporated into the secure operating system 35.

In summary, because the secure operating system 35 in some embodiments does not store information to or retrieve information from the host computer's non-volatile memory, the device 10 provides for several advantages. First, since the device 10 loads its own secure operating system 35, the user need not worry about the security of the operating system already loaded onto the host computer while performing private online transactions or other computing tasks. Moreover, the probability that malware, such as spyware, stored on the host computer's HDD will monitor or otherwise compromise the privacy of online transactions performed using the host computer is reduced because the secure operating system 35 does not access the host computer's HDD. Second, since substantially no data is stored to the host computer from the device 10, there are few, if any, traces of financial or other private information that are left behind on the host computer once the device 10 is removed. Moreover, any private information stored in the host computer's volatile memory can be irretrievably erased by command from the secure operating system 35 or by cycling the power supply to the volatile memory. Third, since no data is stored to the device 10 from the HDD of the host computer, the probability that malware may be transferred from the computer to the device is reduced.

In some embodiments, the device 10 also includes a second read/writable (R/W) memory module 36. The R/W memory module 36 can also be secured (e.g., biometrically) so that its accessibility can be based, at least in part, on whether a user has successfully authenticated his identity. The R/W module 36 can include, for example, secure application data 38 and secure user data 40.

For example, the application memory module 38 can store information from one or more of a user's credit cards, financial accounts, building door access codes, vehicle lock and ignition system codes, combinations of the same, or the like. The R/W memory module 36 also includes a user data module 40 that stores any type of electronic information that a user wishes to secure. This may include text documents and multimedia files, for example. In other embodiments, the R/W memory module 36 may function with or without the application memory module 38 and/or the user data module 40. In certain embodiments, the user downloads information to the application memory module 38 through a host computer coupled thereto.

The device 10 can also include a biometric sensor 30 to biometrically authenticate the identity of a user. In one embodiment, the biometric sensor 30 is a fingerprint reader. In other embodiments, the biometric sensor 30 can be a retinal or iris scanner, a voice recognition unit, a face recognition unit, a hand geometry recognition unit, combinations of the same, or other like biometric sensors. As described herein, the device 10 can be initially registered with unique biometric identifying information of a user. Thereafter, the device 10 can advantageously deny the completion of certain in-person and online transactions unless the user successfully biometrically authenticates his identity with the biometric sensor 30.

The biometric sensor 30 can be coupled to other components of the device 10, such as the processor 32 or the memory modules 34, 36 via an electrical bus 42 in order to control the operation of one or more such components. For example, one or more components of the device 10 may be configured to require a user to successfully biometrically authenticate his identity before becoming operative. In one embodiment, the device 10 is configured so that one or both of the memory modules are inaccessible without a user first biometrically authenticating his identity via the biometric sensor 30. Thus, the memory modules can be biometrically-secured.

Once a user's biometric information is successfully authenticated, or the user's identity is otherwise authenticated, the secured components of the device 10 may remain operative for the duration of a session. The session may have a pre-determined length or can end after a pre-determined period of inactivity. In other embodiments, a session may consist of the completion of a single transaction, and/or the user may manually end the session. Other session lengths and types are also possible and will be apparent to those of ordinary skill in the art from the disclosure herein.

Although the device 10 has been described with respect to particular embodiments, other arrangements of the device 10 may be used. For instance, the device 10 may function without all the components depicted in FIG. 1. In other embodiments, the portable device 10 can include additional components, such as additional memory modules, input devices, communication interfaces, and the like. In some embodiments, components of the portable device 10 can be interconnected without the use of the electrical bus 42 illustrated in FIG. 1. For example, one or more of the components of the device 10 can have a dedicated connection to the processor 32.

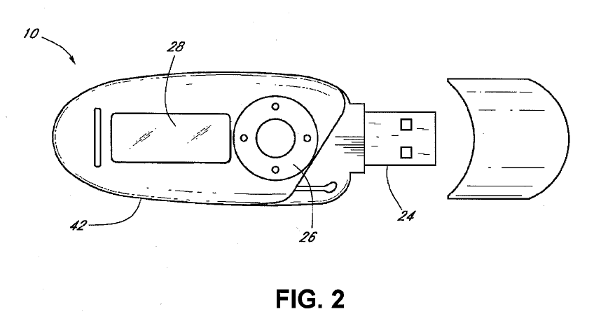

FIG. 2 illustrates one embodiment of the portable device of FIG. 1. As shown, the components of the device 10 can be assembled into a housing 42. The housing 42 shown in FIG. 2 provides for an aesthetically pleasing design of the device 10. Also shown in FIG. 2 are the interface 24 (USB port), a display 28, and an input device 26, such as a scroll wheel. In some embodiments, the housing 42 includes tamper-proof features. While FIG. 2 illustrates the device 10 as a USB-type key, in other embodiments the device 10 can be a cell phone, a PDA, a laptop computer, combinations of the same, or the like.

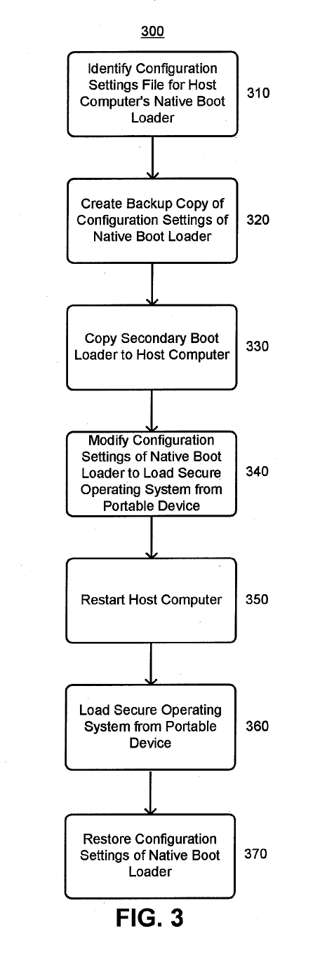

FIG. 3 is a flow chart of an embodiment of a method 300 for loading a secure operating system 35 from a portable device (e.g., the portable device 10 of FIG. 1) onto a host computer. Initially, prior to executing the method 300, a user starts the host computer and normally boots the native operating system that is installed on the host computer. The native operating system may be, for example, WINDOWS XP, WINDOWS VISTA, or WINDOWS 7, all of which are available from Microsoft Corp. In addition, the native operating system may be Mac OS X (e.g., Snow Leopard, Lion, etc.), which is available from Apple Inc. Moreover, the native operating system may be Linux (e.g., Fedora, Ubuntu, etc.). The method 300 can also be used in conjunction with host computers having other native operating systems.

The user inserts the device 10 into a USB port of the host computer. In some embodiments, the interface between the device 10 and the host computer is not a USB port, and in those embodiments communication between the device 10 and the host computer 50 can be established according to the specific interface 24 chosen. In some embodiments, the device 10 includes a start module 58 that can be, for example, a program that is executed by the host computer automatically when a connection is established between the device 10 and the host computer. Alternatively, a user can manually select to run the start module 58. The start module 58 allows a user to select one of several options when the device 10 is communicatively coupled to a host computer. For example, in certain embodiments, the user can select to load the secure operating system 35, for example, by performing a re-boot of the host computer. In some embodiments, the start module 58 requires the user to authenticate his identity (e.g., biometrically or using a password) before beginning the process to load the secure operating system 35 and/or at other times during the processes described herein.

As discussed herein, the device 10 can include a read-only memory module 34 and a R/W memory module 36. In some embodiments, the read-only memory module 34 includes the secure operating system 35 and is assigned a volume label such as “SecureOS.” In some embodiments, the read-only memory module 34 is configured with a filing system such as File Allocation Table (FAT) or New Technology File System (NTFS), though other file systems can also be used. The R/W memory module 36 can be assigned a volume label such as “Private.” In some embodiments, the R/W memory module 36 is configured with a Linux-based file system, though others can also be used. A Linux-based file system may be advantageous in the case where the secure operating system 35 is Linux because this can offer ease-of-use in reading and writing files to and from the R/W memory module 36 when the host computer is operating under the control of the secure operating system 35. The read-only and R/W memory modules can use the same or different file systems.

When the device 10 is coupled to the host computer, the start module 58 searches the drive letter assigned to each of the “SecureOS” and “Private” labels on the portable device 10. In addition, if, for example, the user elects to access files in the R/W memory module 36, the start module 58 can require the user to authenticate his identity. Once the user's identity has been authenticated, the start module 58 can load a Linux-compatible driver (e.g., a Second Extended Filesystem (ext2) driver), if necessary, into the RAM of the host computer to allow for communication with the R/W memory module 36.

If the user elects to load the secure operating system 35, the start module 58 may check the memory modules of the device 10 for a file that indicates whether the secure operating system 35 has previously been successfully booted on the particular host computer being used. In addition, the start module 58 may uninstall the driver that was loaded in order to communicate with the R/W memory module 36, if necessary.

The method 300 shown in FIG. 3 may then be executed. In some embodiments, the method 300 begins with step 310 where a configuration module 52, which can be called by the start module 58, identifies the native boot loader that is installed on the host computer for the purpose of loading the native operating system that is installed on the host computer when the host computer is booted. The configuration module 52 can also be configured to identify a file on the host computer that includes configuration settings for the native boot loader. The configuration settings may include, for example, one or more pointers to the location(s) of data to be loaded by the native boot loader. Once the configuration settings of the native boot loader on the host computer are identified, the configuration module 52 can create a backup copy of the configuration settings of the native boot loader. In some embodiments, the configuration module 52 may also create a backup copy of the native boot loader.

If, for example, the native operating system is Windows XP, the native boot loader may be NT Loader (NTLDR) and the boot loader configuration settings can be stored in the boot.ini file on the host computer. In such cases, the configuration module 52 may be configured to identify the boot.ini file and to store a backup copy of it as boot.bak, or some other name. In some embodiments, the backup copy of the configuration settings of the native boot loader is stored on the host computer itself. More particularly, the backup copy of the configuration settings of the native boot loader may be stored in the same directory as the original file that contains the configuration settings for the native boot loader.

In an alternative example, the native operating system may be Windows Vista or Windows 7. In either of these cases, the native boot loader may be the Windows Boot Manager (BOOTMGR). In such cases, the configuration module 52 may be configured to locate the Boot Configuration Data (BCD), which includes configuration settings for the Windows Boot Manager. The configuration module 52 may create a backup copy of the BCD.

In yet another alternative example, the native operating system may be Linux. The Linux operating system may use a boot loader such as the Grand Unified Bootloader (GRUB). In this case, the configuration module 52 may locate the GRUB configuration file of the native operating system and create a backup copy.

At step 330 of the method 300, the configuration module 52 can load a secondary boot loader 51 from the device 10 to the host computer. The secondary boot loader 51 is stored in, for example, the read-only memory module 34 of the device 10. In some embodiments, the secure operating system 35 is Linux and, thus, the secondary boot loader 51 is a Linux-based boot loader such as GRUB. Therefore, in some embodiments, the configuration module 52 copies GRUB files such as GRLDR and GRLDR.bin to the host computer. The secondary boot loader 51 can be stored on the host computer in, for example, the same file path as the native boot loader of the host computer.

At step 340, a modification module 53 can be used to modify the configuration settings of the native boot loader in such a manner so as to cause the secure operating system 35 from the portable device 10 to be loaded into the RAM of the host computer in place of the native operating system that is installed on the host computer. For example, the configuration settings of the native boot loader (e.g., the boot.ini, BCD, or GRUB configuration files) can be modified so as to point to the secondary boot loader 51 that was stored on the host computer from the portable device. In this manner, the native boot loader of the host computer can be configured so that, on the proximate restart of the host computer, the native boot loader loads the secondary boot loader 51 from the portable device 10 instead of the native operating system of the host computer.

At step 350, a restart module 58 54 gives a command to the host computer to restart. When the host computer restarts, the BIOS or Extensible Firmware Interface (EFI) of the host computer checks the boot device priority settings and attempts to boot from the highest priority device. In many cases, this will be the HDD of the host computer.

Note that the device 10 does not alter the boot priority settings of the BIOS or EFI of the host computer. There is no specific requirement as to the boot priority (typical priority is HDD first, CD second, etc.) of the device 10 (e.g., a USB mass storage device) in the BIOS or EFI of the host computer, and even if there are bootable devices with higher boot priority, the secure operating system 35 can still be booted from the device 10 according to the methods described herein. Accordingly, in some embodiments, it is unnecessary for the user to have access to the BIOS of the host computer in order to boot the secure operating system 35 from the device 10. This can be advantageous because it may be desirable for many end users not to have access to the BIOS or EFI because they could accidentally or maliciously change settings that will disable or damage the host computer.

After the host computer is restarted, the BIOS or EFI of the host computer loads the native boot loader from, for example, the Master Boot Record of the host computer's HDD. However, the native boot loader has been previously modified so as to load the secure operating system 35 from the portable device 10 instead of the native operating system installed on the host computer. As discussed above, this can be accomplished in some embodiments by editing the configuration settings of the native boot loader to point to the secondary boot loader 51 rather than the native operating system. In such embodiments, the native boot loader therefore loads the secondary boot loader 51.

At step 360, a loading module 54 loads the secure operating system 35 from the device 10 to the host computer. For example, in cases where the native boot loader of the host computer has loaded the secondary boot loader 51, the secondary boot loader 51 can be configured so as to load the secure operating system 35 from the portable device 10. In some embodiments, the secondary boot loader 51 may include an algorithm that is configured to search peripheral devices that are attached to the host computer in order to identify the read-only memory module 34 of the portable device 10 and the SecureOS label. Once the secure operating system 35 is located by the secondary boot loader 51, the secondary boot loader 51 loads the secure operating system 35 on to the host computer by, for example, loading the secure operating system 35 into the host computer's RAM. Once the secure operating system 35 is loaded onto the host computer, it controls the resources and operation of the host computer in a manner similar to the native operating system that is installed on the host computer. However, the secure operating system 35 controls the host computer independently of the native operating system, thus achieving the advantages described herein. For example, in some embodiments, the secure operating system 35 operates in the host computer's volatile memory, generally without reading data from, or storing data to, the host computer's non-volatile memory, such as its HDD. Thus, after the user is finished completing the desired transactions, substantially no personal or private information is left on the host computer 50. In addition, while the secure operating system 35 is loaded, a deactivation module 56 can be used to deactivate the HDD, as discussed herein.

At step 370, a restoration module 57 can be configured to restore the configuration settings of the host computer's native boot loader by using the backup copy of the configuration settings that was made at step 320. In some embodiments, the restoration module 57 deletes the secondary boot loader 51 from the host computer. In addition, the restoration module 57 can restore the configuration settings of the native boot loader by, for example, deleting the altered configuration settings file and renaming the backup copy with its original filename. In this manner, the state of the host computer is restored such that, upon the proximate restart of the host computer, the native boot loader will load the native operating system of the host computer rather than the secondary boot loader 51 and/or the secure operating system from the device 10. The restoration module 57 can be activated at any time, whether the host computer is operating under the control of the native operating system or the secure 35 operating system from the portable device 10.

In some embodiments, the native operating system is Mac OS X. In such embodiments, when the portable device is communicatively coupled to the host computer, the start module 58 can be loaded, the user authenticated, a driver for communicating with the R/W memory module 36 installed, etc., as discussed above. The configuration module 52 can modify the Mac OS X boot loader in a manner to cause it to load the secure operating system 35 from the portable device 10 after a restart of the host computer. This can be done, for example, by using the “bless” command to make the portable device 10 bootable. This modifies the EFI of the host computer in a manner that causes it boot from the portable device 10 whenever it is communicatively coupled to the host computer at a time when the host computer is started.

As discussed above, the start module 58 offers the user several options when the portable device 10 is communicatively coupled to the host computer. One of such options is to load the secure operating system 35, as discussed above. In addition, the start module 58 may be configured to allow the user to perform a computing task under the control of the native operating system installed on the host computer. For example, the start module 58 may load a driver to allow the host computer to communicate with the R/W memory module 36 and, after authenticating the user's identity, allow the user to transfer computer files between the host computer and the R/W memory module 36. In some embodiments, such files are scanned for security breaches before being stored to the R/W memory module 36. For example, the files can be scanned for viruses, other malware, or the like. If a threat is detected, the user can be alerted and questioned as to whether or not to proceed.

The start module 58 may also allow a user the option to print a document from a print queue that has been previously stored on the portable device 10. For example, the user may have previously used the portable device 10 on a host computer that did not have access to a printer. The user could have selected to send a document to a print queue to be stored on the portable device 10. Later, this print queue can be accessed from another host machine that does have access to a printer.

The start module 58 can allow the user to change a password, access a webpage from a previously-saved link, or access help files. In addition, the start module 58 can be configured to allow the user to access the Internet on the host computer under the control of the native operating system while protecting the user's identity by changing the host machines MAC address and/or IP number via a proxy server. The start module 58 can also activate the restoration module 57 in order to repair or restore the host computer's native boot loader and configuration settings at any time, as discussed above.

The portable device 10 can also be used to cold boot the secure operating system 35 on the host computer. For example, the secure operating system 35 can be cold booted on host computers that support USB booting natively. In such embodiments, the portable device 10 may include a modified version of a boot loader such as Syslinux. In addition, the read-only memory module 34 of the portable device 10 can be configured with HDD emulation. The boot loader (e.g., Syslinux) can be modified to appropriately point to the location of the secure operating system 35 in order to compensate for differences in geometry between the portable device 10 (e.g., a USB mass storage device) and a HDD. For example, a boot loader may typically be located at sector zero on an HDD. However, the geometry of the portable device 10 may have a different geometry without sectors. Thus, the boot loader can be modified so as to update the appropriate pointers to compensate for these differences in geometries. In some embodiments, on cold boot the system can be setup in BIOS to boot from a USB device (e.g., device 10) or the user can select the device from the boot menu via system function keys (usually F12). Once the host computer is redirected via either means, the system, like in its native booting mode, identifies a bootable device. The device 10 can be made bootable via a process that includes creating a working MBR code and an active partition on the read-only memory module 35 of the device 10. For example, the syslinux MBR code (mbr.bin) can be written into the master boot record of the device 10, and mark first partition as active (bootable).

In some embodiments, to the extent that computer software is used to implement any of the modules described herein, any text files included with the software can be made Unicode-compliant. Unicode compliance allows the portable device 10 to be used on host computers throughout the world in countries that speak different languages. Without Unicode compliance, it is possible that a host computer may not be able to properly execute software instructions for performing the methods described herein if the host computer were to use a different encoding scheme for text files than that which was used to establish the text files of software on the portable device.

Many other variations than those described herein will be apparent from this disclosure. For example, depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The foregoing disclosure has oftentimes partitioned devices and system into multiple modules (e.g., software functional blocks, components, computers, servers) for ease of explanation. It is to be understood, however, that one or more modules may operate as a single unit. Conversely, a single module may comprise one or more subcomponents that are distributed throughout one or more locations. Further, the communication between the modules may occur in a variety of ways, such as hardware implementations (e.g., over a network, serial interface, parallel interface, or internal bus), software implementations (e.g., database, passing variables), or a combination of hardware and software.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. Unless stated otherwise, a software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A device for establishing a secure computing environment on a host computer, the device comprising:
an interface configured to couple to the host computer;
a configuration module configured to identify a file that comprises configuration settings of the host computer's native first boot loader that is used to load a native first operating system that is installed on the host computer, and to create a backup copy of the configuration settings on the host computer;
a memory comprising a second operating system;
a modification module configured to modify the configuration settings of the host computer's native first boot loader to cause the second operating system to be loaded from the device in place of the native first operating system; and
a restart module configured to cause the host computer to restart.

2. The device of claim 1, further comprising loading module configured to load the second operating system into volatile memory of the host computer after the host computer has restarted.

3. The device of claim 2, wherein the host computer is controlled using the second operating system independent of the native first operating system.

4. The device of claim 3, further comprising a deactivation module configured to deactivate a hard disk drive of the host computer while the host computer is controlled using the second operating system.

5. The device of claim 1, wherein the configuration module is configured to copy a second boot loader from the device to the host computer and to modify the configuration settings of the host computer's native first boot loader to load the second boot loader.

6. The device of claim 5, wherein the second boot loader is configured to load the second operating system.

7. The device of claim 5, wherein the second boot loader is configured to search peripherals that are communicatively coupled to the host computer and to identify the device.

8. The device of claim 1, further comprising a restoration module configured to restore the configuration settings of the host computer's native first boot loader using the backup copy after the host computer is restarted, thereby configuring the host computer to boot the native first operating system on the next subsequent restart of the host computer.

9. The device of claim 1, wherein the boot device priority in the BIOS of the host computer is not modified.

10. The device of claim 1, further comprising an authentication module configured to authenticate the identity of a user before the configuration settings of the host computer's native first boot loader are modified.

11. The device of claim 1, wherein the host computer's native first boot loader comprises an NTLDR file, and wherein the modification module is configured to modify a boot.ini file.

12. The device of claim 1, wherein the host computer's native first boot loader comprises a BOOTMGR file, and wherein the modification module is configured to modify a BCD file.

13. The device of claim 1, wherein the device is biometrically-secured.

14. The device of claim 1, wherein the memory comprising the second operating system is read-only.

15. A method for establishing a secure computing environment on a host computer, the method comprising:
identifying a file that comprises configuration settings of the host computer's native first boot loader that is used to load a native first operating system that is installed on the host computer;
creating a backup copy of the configuration settings on the host computer;
modifying the configuration settings of the host computer's native first boot loader to cause a second operating system to be loaded from an external device that is communicatively coupled to the host computer in place of the native first operating system; and
causing the host computer to restart,
wherein the method is at least partially performed by computer hardware.

16. The method of claim 15, further comprising loading the second operating system from the external device into volatile memory of the host computer after the host computer has restarted.

17. The method of claim 16, wherein the host computer is controlled using the second operating system from the external device independent of the native first operating system.

18. The method of claim 17, further comprising deactivating a hard disk drive of the host computer while the host computer is controlled using the second operating system from the external device.

19. The method of claim 15, further comprising, before causing the host computer to restart, copying a second boot loader from the external device to the host computer and modifying the configuration settings of the host computer's native first boot loader to load the second boot loader.

20. The method of claim 19, wherein the second boot loader is configured to load the second operating system.

21. The method of claim 19, wherein the second boot loader is configured search peripherals that are communicatively coupled to the host computer and to identify the external device.

22. The method of claim 15, further comprising restoring the configuration settings of the host computer's native first boot loader using the backup copy after the host computer is restarted, thereby configuring the host computer to boot the native first operating system on the next subsequent restart of the host computer.

23. The method of claim 15, wherein the boot device priority in the BIOS of the host computer is not modified.

24. The method of claim 15, further comprising authenticating the identity of a user prior to modifying the configuration settings of the host computer's native first boot loader.

25. The method of claim 15, wherein the host computer's native first boot loader comprises an NTLDR file, and wherein modifying the configuration settings of the host computer's native first boot loader comprises modifying a boot.ini file.

26. The method of claim 15, wherein the host computer's native first boot loader comprises a BOOTMGR file, and wherein modifying the configuration settings of the host computer's native first boot loader comprises modifying a BCD file.

27. Non-transitory computer-readable storage comprising instructions that, when executed, establish a secure computing environment on a host computer according to a method that comprises:
identifying a file that comprises configuration settings of the host computer's native first boot loader that is used to load a native first operating system that is installed on the host computer;
creating a backup copy of the configuration settings on the host computer;
modifying the configuration settings of the host computer's native first boot loader to cause a second operating system to be loaded from an external device that is communicatively coupled to the host computer in place of the native first operating system; and
causing the host computer to restart.

28. The non-transitory computer-readable storage of claim 27, wherein the method further comprises loading the second operating system from the external device into volatile memory of the host computer after the host computer has restarted.

29. The non-transitory computer-readable storage of claim 27, wherein the method further comprises, before causing the host computer to restart, copying a second boot loader from the external device to the host computer and modifying the configuration settings of the host computer's native first boot loader to load the second boot loader, wherein the second boot loader is configured to load the second operating system.

30. The non-transitory computer-readable storage of claim 27, wherein the method further comprises restoring the configuration settings of the host computer's native first boot loader using the backup copy after the host computer is restarted, thereby configuring the host computer to boot the native first operating system on the next subsequent restart of the host computer.
